(19) United States
(12) Patent Application Publication
(10) Pub. No.: US 2013/0162522 A1
(43) Pub. Date: Jun. 27, 2013

(54) METHOD AND APPARATUS FOR CONTROLLING POWER OF DISPLAY DEVICE USING FRONTAL FACE DETECTOR

(71) Applicants: Seung Min CHOI, Daejeon (KR); Dae Hwan HWANG, Daejeon (KR); Jae II CHO, Daejeon (KR)

(72) Inventors: Seung Min CHOI, Daejeon (KR); Dae Hwan HWANG, Daejeon (KR); Jae II CHO, Daejeon (KR)

(73) Assignee: ELECTRONICS AND TELECOMMUNICATIONS RESEARCH INSTITUTE, Daejeon (KR)

(21) Appl. No.: 13/586,399

(22) Filed: Aug. 15, 2012

(30) Foreign Application Priority Data
Dec. 27, 2011 (KR) 10-2011-0143642

(51) Int. Cl. G09G 5/00

(52) U.S. Cl. 345/156

(57) ABSTRACT

Disclosed are a method and an apparatus for controlling power of a display device using a frontal face detecting device. The method for controlling power of a display device includes: determining whether a face of a user is present in front of the display device; confirming a power state of the display device; and repeatedly performing the determining of whether the face of a user is present according to determined presence of the face and the confirmed power state to control power of the display device. The method intelligently recognizes a use purpose of a user from the display device, thereby managing power of the display device, and controlling power of the display device without requiring a separate action by a user for managing device power.

### CROSS-REFERENCE TO RELATED APPLICATIONS

This application claims priority to and the benefit of Korean Patent Application No. 10-2011-0143642 filed in the Korean Intellectual Property Office on Dec. 27, 2011, the entire contents of which are incorporated herein by reference.

### TECHNICAL FIELD

The present invention relates to a method for managing power of a display device using a face detection result based on an image of a human computer interaction (HCI) technology.

### BACKGROUND ART

Because power consumption of a display device is at a level which cannot be ignored, various technologies have been designed and presently used to manage power consumption. A power control method that senses interruption of an input of a key board or a mouse is unique as a case of not requiring an additional sensor to be mounted in order to manage power. Because there is a small difference in a performance aspect in comparison with other methods, the power control method has widely been used. In a case of using a technology of determining presence of a human using an existing infrared or ultrasonic sensor, when the user stays around the display device, the technology can determine the presence of a human but cannot determine whether a corresponding device is being used. The technology of determining the presence of the human has a disadvantage in that the display device is continuously turned-on. Since it is difficult to distinguish a case of whether a user appears to use the display device from a case where the user passes through a periphery of a display sensor, the display device is turned-on at any time or responds too slowly, which inconveniences the user.

In a case of managing power using a key board or a mouse, the user can control a timeout time. However, when the time is determined short, the user needs to maintain input at any time. When the time is determined long, only when the user stops use of the display device for a while time, power management is operated. Accordingly, the case of managing power using the key board or the mouse has a disadvantage in that it has difficulty in sensing an idle period which may occur only for a moment during use. To use a device, the user needs to perform physical input. After the physical input, a time difference occurs until the device is operated.

### SUMMARY OF THE INVENTION

The present invention has been made in an effort to provide a method and an apparatus for controlling power of a display device according to presence of a frontal face and a power state of the display device using a frontal face detector.

The present invention also has been made in an effort to provide a method for managing power of a display device using a frontal face detection result of a user in order to minimize a harmful action such as heat or an electromagnetic wave that occurs during use of the display device as well as managing power of the display device.

An exemplary embodiment of the present invention provides a method for controlling power of a display device based on face detection, the method including: determining whether a face of a user is present in front of the display device; confirming a power state of the display device; and repeatedly performing the determining of whether the face of a user is present according to determined presence of the face and the confirmed power state to control power of the display device.

The face whose the presence is determined in the determining of whether the face of a user is present may be a frontal face of the user.

The determining of whether the face of a user is present according to the presence of the determined face of the user and the confirmed power state to control power of the display device is repeatedly performed using a preset time interval.

The controlling of the power of the display device may further include comparing a repeated variable defining time or the number of times repeatedly performing the determining whether the face of a user is present with a preset threshold, and the power may be controlled using the repeated variable.

The comparing of the repeated variable may be performed when it is determined that the face of the user is absent in the determining of whether the face of a user is present and it is confirmed that a power state of the display device is turned-off.

The controlling of the power of the display device may further include resetting the repeated variable, and the resetting of the repeated variable may be performed when it is determined that the face of the user is present in the determining of whether the face of a user is present.

The controlling of the power of the display device may further include turning-off the power of the display device, and the turning-off of the power of the display device may be performed when the repeated variable exceeds a preset threshold.

The controlling of the power of the display device may further include turning-on the power of the display device, and the turning-on of the power of the display device may be performed when it is determined that the face of the user is present in the determining whether the face of a user is present and it is confirmed that a power state of the display device is turned-off.

The frontal face determined in the determining of whether the face of a user is present may be a non-rotation face of less than or equal to a preset threshold angle.

The frontal face determined in the determining whether the face of a user is present may be a non-side face of less than or equal to a preset threshold angle.

The preset time interval may be set in consideration of a frame rate of an apparatus for detecting a face performing the determining of whether the face of a user is present or is changed according to performance of the display device.

Another exemplary embodiment of the present invention provides an apparatus for controlling power of a display device based on face detection, the apparatus including: a face detector configured to determine of whether a face of a user is present in front of the display device; a power confirmer configured to confirm a power state of the display device; and a power controller configured to control power of the display device using a result of repeatedly performing the face detection by the face detector according to determined presence of the face and the confirmed power state.

The face detector may include a front face confirmer configured to confirm whether the face whose presence is determined is a frontal face of the user.

The determining whether the face of a user is present may be achieved according to the presence of the determined face of the user and the confirmed power state to control power of the display device is repeatedly performing the using a preset time interval.

The display power controller may further include a repeated variable manager configured to manage a repeated variable defining time or the number of times repeatedly performing the detecting of the face by the face detector.

The repeated variable manager may include a repeated variable confirmer configured to compare the repeated variable with a preset threshold; and a repeated variable resetter configured to reset the repeated variable, and the power controller may control the power of the display device using the repeated variable.

The repeated variable confirmer may perform the comparison of the repeated variable with the preset threshold value when it is determined that the face of the user is absent in the determining of whether the face of a user is present and it is confirmed that a power of the display device is turned-off.

The repeated variable resetter may reset the repeated variable when the face detector determines that the face of a user is present.

The power controller may turn-off the power of the display device when the repeated variable exceeds a preset threshold.

The power controller may turn-on the power of the display device when it is determined that the face detector determines that the face of the user is present and it is confirmed that the power of the display device is turned-off.

The present invention may provide a method and apparatus for controlling power of a display device according to presence of detection of a frontal face and a power state of the display device using a frontal face detector to intelligently recognize a use purpose of a user from the display device even though the user stays around the display device in comparison with a case of using an existing passive sensor, thereby managing the power of the display device. Because the user may not recognize power management of the display device in comparison with an input interrupt scheme of a key board or a mouse. When using the display device, because the user views an approached device from a remote location without requiring a separate action, the device is rapidly operated in comparison with an existing method.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a flowchart illustrating a method for controlling power of a display device based on face detection according to an exemplary embodiment of the present invention.

FIG. 2 is a detailed flowchart illustrating a power control step of the method for controlling power of a display device based on face detection according to an exemplary embodiment of the present invention.

FIG. 3A to 3F are exemplary diagrams illustrating results performing face detection in the method for controlling power of a display device based on face detection according to an exemplary embodiment of the present invention.

FIG. 4 is a block diagram illustrating an apparatus for controlling power of a display device based on face detection according to an exemplary embodiment of the present invention.

FIG. 5 is a detailed block diagram illustrating a repeated variable manager of the apparatus for controlling power of a display device based on face detection according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. First of all, we should note that in giving reference numerals to elements of each drawing, like reference numerals refer to like elements even though like elements are shown in different drawings. In describing the present invention, well-known functions or constructions will not be described in detail since they may unnecessarily obscure the understanding of the present invention.

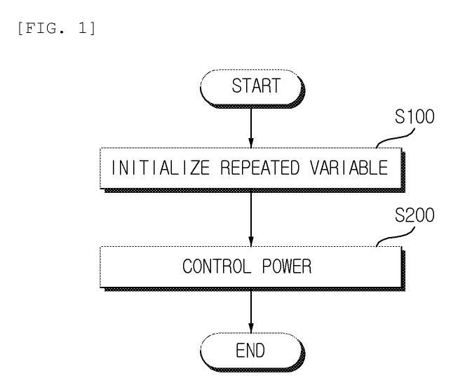

FIG. 1 is a flowchart illustrating a method for controlling power of a display device based on face detection according to an exemplary embodiment of the present invention.

Referring to FIG. 1, the method for controlling power of a display device based on face detection according to an exemplary embodiment of the present invention includes initializing a repeated variable (S100) and controlling power (S200).

The initializing of the repeated variable (S100) may initialize a variable defining a time for controlling power of the display device and a variable defining a time interval advancing to a threshold time when a face is not detected by a repeated variable manager 300.

In the present exemplary embodiment, time information determined by a user as a device is in an idle period is defined as TMAX and TMIN. That is, if it is determined that the device is not used during TMAX-TMIN time, power of the device may be controlled. Accordingly, a repeated variable defining time or the number of times repeatedly performed may be initialized as TMAX being time_remain. When the face is not detected, a time interval moving from TMAX to TMIN is defined as a TDELTA. The TDELTA is connected with a frame rate of a face detector, and TAMX, TMIN, and TDELTA may be changed according to performance and a characteristic of a used system.

The controlling of the power (S200) repeatedly performs the face detecting step according to presence of a face and the determined power state by the power controller 400 to control power of the display device.

The repeatedly performing of the face detecting step may be achieved at a preset time interval. In the present exemplary embodiment, the preset time interval may be the TDELTA set during the initializing of the repeated variable (S100).

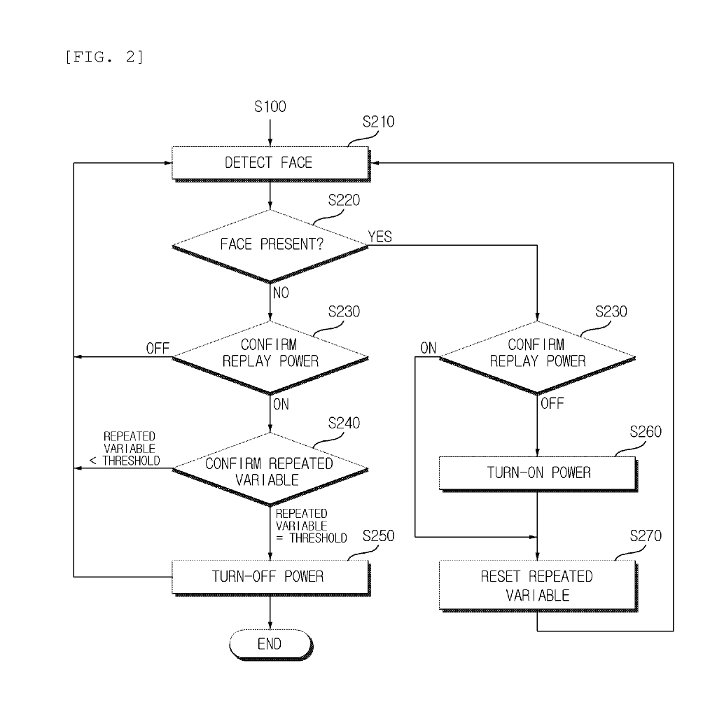

The controlling of the power (S200) will be described in detail with reference to FIG. 2.

FIG. 2 is a detailed flowchart illustrating a power control step of the method for controlling power of a display device based on face detection according to an exemplary embodiment of the present invention.

Referring to FIG. 2, the controlling of the power of the method for controlling power of a display device based on face detection according to an exemplary embodiment of the present invention includes a step S210 of detecting a face, a step S220 of confirming presence of the face, a step S230 of confirming power of the display device, a step S240 of confirming a repeated variable, a step S250 of turning-off the display device, a step S260 of turning-on the display device, and a step S270 of resetting the repeated variable.

Step 5210 of detecting the face detects whether a face of a user is present in front of the display device to control the power of the display device by the face detector 100. In the present exemplary embodiment, the display device may include a visual output device including a monitor, a TV, a display board, a street advertizing plate, a projector, a plasma display device, and the like. Step of detecting the face of the user may detect a frontal face from an image input through a camera installed in front of a user viewing the display device.

Step 5220 of confirming the presence of the face confirms whether a frontal face of the user is present from the image detected in step S210 of detecting the face by a frontal face confirmer 110. In the present exemplary embodiment, the face whose presence is determined in the determining whether the face of a user is present (S220) may be a frontal face of the user.

The frontal face may be a non-rotation face of less than or equal to a preset threshold angle and/or a non-side face of less than or equal to a preset threshold value.

In the present exemplary embodiment, to determine the non-rotation face and the non-side face may beforehand by previously obtaining a feature from a face image database the amount and non-face image database, and apply the feature to an image currently input in real time to distinguish a non-face from a face. Accordingly, only frontal face is applied to a previous image database to obtain a classifier using the feature, and the result is applied to detect only the frontal face. In the foregoing manner, a face database allowing a threshold margin having about ±15 if a front view is collected to generate a frontal face classifier, and a face is detected using the generated classifier, so that a frontal non-rotation face is detected.

When an image obtained by transversely rotating an input image by a threshold value based on a center of the image by a desired angle is applied to a frontal face detector to detect a transversely rotated face. In the present exemplary embodiment, the input image may be two-dimensionally rotated (in only clockwise and counterclockwise directions) by a desired angle and the rotated image may be applied to a face detection classifier to detect a non-side and non-rotation face.

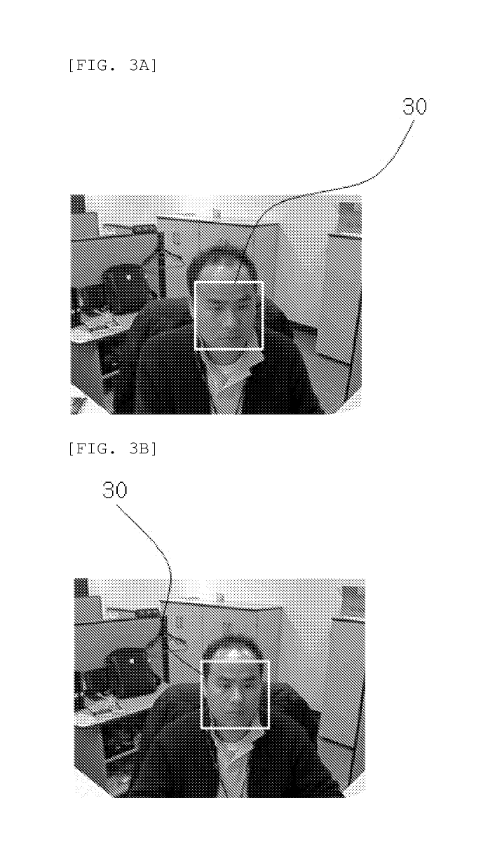

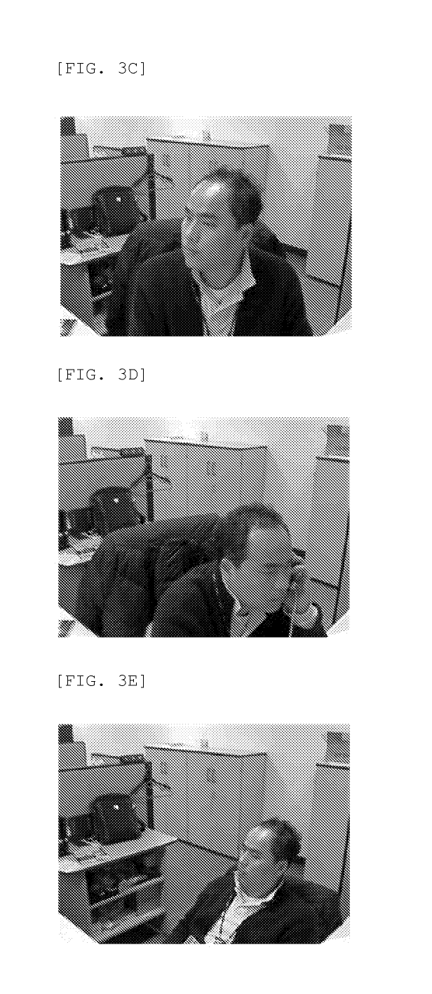

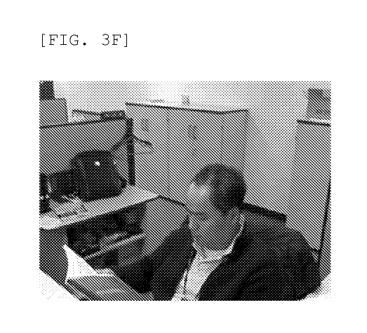

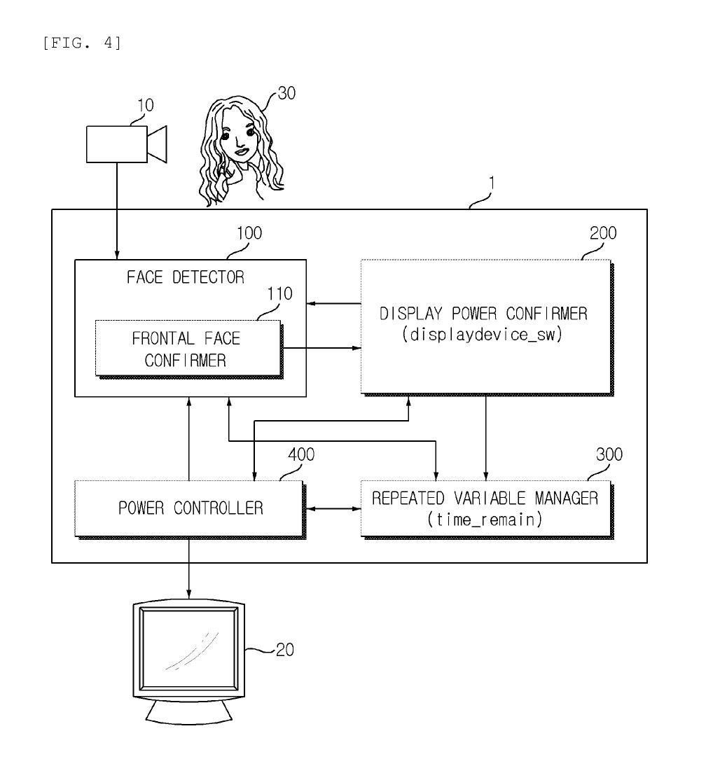

The frontal face detected in the present exemplary embodiment will be described with reference to FIG. 3A to 3F. FIG. 3A to 3F are exemplary diagrams illustrating results performing step S210 of detecting the face and step S220 of confirming the presence of the face in the method for controlling power of a display device based on face detection according to an exemplary embodiment of the present invention. Referring to FIG. 3A to 3F, it can be seen that a non-side and non-rotation face 30 of less than or equal to a preset threshold angle is detected from images FIG. 3A and FIG. 3B. In remaining images FIG. 3C, FIG. 3D, FIG. 3E, and FIG. 3F, because a face is present in the input image or a side or rotation face of equal to or greater than a threshold angle is detected, a frontal face is not detected.

Step S230 of confirming power of the display device determines whether a power state of the display device is on or off by the power confirmer 200. In the present exemplary embodiment, the power state of the display device may be confirmed through a variable displaydevice_sw. Step S230 of confirming power of the display device operates a module for turning-on or a module for turning-off power of the display device according to the presence of the face determined by the frontal face confirmer 110 in step S220 of confirming the presence of the face. Accordingly, step S220 of confirming presence of the face will be described by either a case of determining that the frontal face is present or a case of determining that the frontal face is absent by the frontal face confirmer 110.

When the frontal face confirmer 110 determines that the frontal face is absent in step S220 by confirming the presence of the face, and the display power confirmer 200 confirms that power of the display device is turned-off in step S230 by confirming power of the display device, the display power confirmer continuously determines that there is no user to use the display device, and the process goes to step S210 of detecting a face to detect reappearance of the user.

When the display power confirmer 200 confirms that the power of the display device is turned-on in step S230 of confirming power of the display device, a repeated variable confirmer 310 confirms a repeated variable (S240). Accordingly, in the present exemplary embodiment, step S240 of confirming a repeated variable may be performed when it is determined that the face of the user is absent in step S210 of detecting a face and step S220 of confirming presence of the face and it is confirmed that power of the display device is turned-off in the step S230 of confirming power of the display device.

Step S240 of confirming a repeated variable compares a repeated variable defining time or the number of times repeatedly performing step S210 of detecting a face with a preset threshold by the repeated variable confirmer 310. In the present exemplary embodiment, the repeated variable may be a variable indicating the time repeating step S210 of detecting a face. In the present exemplary embodiment, the repeated variable is defined as time_remain. As described above, the time_remain is reduced by TDELTA being a time interval repeated each time at step S210 of detecting a face that repeats using TMAX set in the initializing of a repeated variable (S100) as an initial value of time_remain. To compare the repeated variable with the preset threshold value may be to compare time_remain reduced by TDELTA with TMIN set in the initializing of a repeated variable (S100) as the threshold value.

Step S250 of turning-off the display device turns-off power of the display device being turned-on by the power controller 400. The present exemplary embodiment may record information indicating the device being turned-off in a variable displaydevice_sw and then the process returns to step S210 of detecting a face. Step S250 of turning-off power of the display device may be performed when the measured repeated variable exceeds a preset threshold value. In the present exemplary embodiment, when the time_remain is less than the TMIN in step S240 of confirming a repeated variable, step S250 of turning-off power of the display device may be performed.

When the frontal face confirmer 110 determines that the frontal face is present in step S220 of confirming presence of the face, and the display power confirmer 200 confirms that the power of the display device is turned-on in step S230 of confirming power of the display device, it is determined that a user wishing to use the display device reappears and the process goes to a step S260 of turning-on the power of the display device.

Step S260 of turning-on the power of the display device turns-on the power of the display device after being turned-off by the power controller 400. Step S260 of turning-on the power of the display device may be performed when it is determined that the face of the user is present in step of detecting a face, and it is confirmed that the power of the display device is turned-off. In the present exemplary embodiment, step S260 of turning-on the power of the display device may turn-on the power of the display device and record information indicating that the device is turned-on in a variable displaydevice_sw in order to confirm whether use of the user for the display device continues or use of the user for the display device stops such that a need to again control the power of the display device occurs by the power controller 400, and then the process goes to a step S270 of resetting a repeated variable.

Step S270 of resetting a repeated variable resets time or the number of times repeating step of detecting a face by the repeated variable manager 300. In the present exemplary embodiment, a repeated variable time_remain reduced by TDELTA being a time interval repeated each time step of detecting a face repeats may be reset as a IMAX set in step S100 of initializing the repeated variable. Step S270 of resetting a repeated variable may be performed when the repeated variable manager 300 determines whether the face of the user is present in step S210 of detecting a face and step S220 of confirming presence of the face. In more detail, when the frontal face confirmer 110 determines that the face of the user is present in step S220 of confirming presence of the face, and the display power confirmer 200 confirms the power of the display device is turned-on in step S230 of confirming power of the display device or after the power controller 400 turns-on the power of the display device in step S260 of turning-on the power of the display device, step S270 of resetting a repeated variable may be performed.

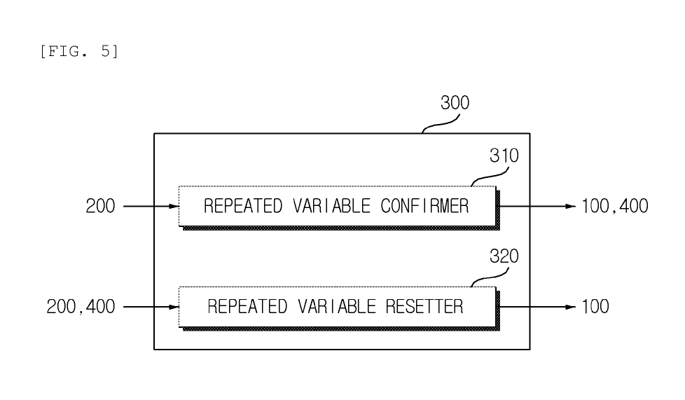

FIG. 4 is a block diagram illustrating an apparatus for controlling power of a display device based on face detection according to an exemplary embodiment of the present invention.

Referring to FIG. 4, an apparatus 1 for controlling power of a display device based on face detection according to an exemplary embodiment of the present invention includes a face detector 100, a display power confirmer 200, a repeated variable manager 300, and a power controller 400. The face detector 100 further includes a frontal face confirmer 110.

As described above, the face detector 100 detects whether a face 300 of a user is present in front of a display device 200 in order to control power of the display device 200 (S210). The face detector 100 may detect a frontal face 300 from an image input through a camera 100 installed in front of a user viewing the display device.

The frontal face confirmer 110 confirms whether a frontal face of the user is present in the detected image by the face detector 100. In the present exemplary embodiment, the face whose presence is determined by the frontal face confirmer 110 may be a frontal face of the user.

The display power confirmer 200 determines whether power of the display device is turned-on or turned-off. In the present exemplary embodiment, the power state of the display device may be confirmed through a variable displaydevice_sw (S230). The power confirmer 200 of the display device may perform a module for turning-on or a module for turning-off the power of the display device according to presence of a face determined by the frontal face confirmer 110.

When the frontal face confirmer 110 confirms that the frontal face is absent, and the display power confirmer 200 confirms that power of the display device is turned-off, the display power confirmer 200 continuously determines that there is no user wishing to use a display device, and the face detector 100 detects a face to detect reappearance of the user (S210). When the display power confirmer 200 confirms that the power of the display device is turned-on, the display power confirmer 200 confirms the repeated variable (S240).

The repeated variable manager 300 controls repeatedly performing of the face detector 100 of the apparatus for controlling power of the display device based on face detection using information input from the display power confirmer 200 or the power controller 400. The repeated variable manager 300 will be described in detail with reference to FIG. 5.

FIG. 5 is a detailed block diagram illustrating a repeated variable manager of the apparatus for controlling power of a display device based on face detection according to an exemplary embodiment of the present invention.

The repeated variable manager 300 includes a repeated variable confirmer 310 and a repeated variable resetter 320.

The repeated variable confirmer 310 compares a repeated variable defining time or the number of times repeating the step S210 of detecting a face with a preset threshold value by the face detector 100 (S240).

The repeated variable resetter 320 resets the repeated variable defining time or the number of times repeating the step S210 of detecting a face by the face detector 100 (S270). In the present exemplary embodiment, the repeated variable time_remain reduced by TDELTA being a time interval repeated each time step S210 of detecting a face repeats may be reset as TMAX set in the initializing of a repeated variable (S100). When the repeated variable resetter 320 resets the repeated variable, the face detector 100 detects the face using the reset repeated variable (S210).

The power controller 400 turns-on (S260) or turns-off (S250) the power of the display device using information input from the display power confirmer 200 or the repeated variable manager 300. When the power of the display device is turned-off, the present exemplary embodiment records information indicating that the display device is turned-off in a variable displaydevice_sw and the face detector 100 again detects the face (S210) in order to detect a face of a user who will use the display device. When the power of the display device is turned-on, the present exemplary embodiment records information indicating that the device is turned-on in a variable displaydevice_sw in order to confirm whether use of the user for the display device continues or use of the user for the display device stops such that a need to again control the power of the display device occurs, and then the repeated variable resetter 320 of the repeated variable manager 300 resets the repeated variable (S270).

Meanwhile, the embodiments according to the present invention may be implemented in the form of program instructions that can be executed by computers, and may be recorded in computer readable media. The computer readable media may include program instructions, a data file, a data structure, or a combination thereof. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A method for controlling power of a display device based on face detection, the method comprising:
determining whether a face of a user is present in front of the display device;
confirming a power state of the display device; and
repeatedly performing the determining whether the face of a user is present according to determined presence of the face and the confirmed power state to control power of the display device.

2. The method of claim 1, wherein the face whose presence is determined in the determining of whether the face of a user is present is a frontal face of the user.

3. The method of claim 1, wherein repeatedly performing the determining of whether the face of a user is present according to presence of the determined face of the user and the confirmed power state to control power of the display device using a preset time interval.

4. The method of claim 3, wherein the controlling of the power of the display device further includes comparing a repeated variable defining time or the number of times repeatedly performing the detecting of the face with a preset threshold, and the power is controlled using the repeated variable.

5. The method of claim 4, wherein the comparing of the repeated variable is performed when it is determined that the face of the user is absent in the determining of whether the face of a user is present and it is confirmed that power of the display device is turned-off.

6. The method of claim 3, wherein the controlling of the power of the display device further includes resetting the repeated variable, and
the resetting of the repeated variable is performed when it is determined that the face of the user is present in the determining whether the face of a user is present.

7. The method of claim 4, wherein the controlling of the power of the display device further includes turning-off the power of the display device, and
the turning-off of the power of the display device is performed when the repeated variable exceeds a preset threshold value.

8. The method of claim 3, wherein the controlling of the power of the display device further includes turning-on the power of the display device, and
the turning-on of the power of the display device is performed when it is determined that the face of the user is present in the determining of whether the face of a user is present and it is confirmed that a power state of the display device is turned-off.

9. The method of claim 2, wherein the frontal face determined in the determining of whether the face of a user is present is a non-rotation face of less than or equal to a preset threshold.

10. The method of claim 2, wherein the frontal face determined in the determining whether the face of a user is present is a non-side face of less than or equal to a preset threshold.

11. The method of claim 3, wherein the preset time interval is set in consideration of a frame rate of an apparatus for detecting a face performing the determining of whether the face of a user is present or is changed according to performance of the display device.

12. An apparatus for controlling power of a display device based on face detection, the apparatus comprising:
a face detector configured to determine whether a face of a user is present in front of the display device;
a power confirmer configured to confirm a power state of the display device; and
a power controller configured to control power of the display device using a result of repeatedly performing the face detection by the face detector according to determined presence of the face and the confirmed power state.

13. The apparatus of claim 12, wherein the face detector includes a front face confirmer configured to confirm whether the face whose the presence is determined is a frontal face of the user.

14. The apparatus of claim 12, wherein the repeatedly performing the determining whether the face of a user is present according to the presence of the determined face of the user and the confirmed power state to control power of the display device using a preset time interval.

15. The apparatus of claim 12, wherein the display power controller further includes a repeated variable manager configured to manage a repeated variable defining time or the number of times repeatedly performing the detecting of the face by the face detector.

16. The apparatus of claim 15, wherein the repeated variable manager includes a repeated variable confirmer configured to compare the repeated variable with a preset threshold value; and
a repeated variable resetter configured to reset the repeated variable, and
the power controller controls the power of the display device using the repeated variable.

17. The apparatus of claim 16, wherein the repeated variable confirmer performs the comparison of the repeated variable with the preset threshold value when it is determined that the face of the user is absent in the determining whether the face of a user is present and it is confirmed that power of the display device is turned-off.

18. The apparatus of claim 16, wherein the repeated variable resetter resets the repeated variable when the face detector determines that the face of a user is present.

19. The apparatus of claim 12, wherein the power controller turns-off power of the display device when the repeated variable exceeds a preset threshold.

20. The apparatus of claim 12, wherein the power controller turns-on power of the display device when the face detector determines that the face of the user is present and it is confirmed that the power state of the display device is turned-off.
